(19) United States
(12) Patent Application Publication
(10) Pub. No.: US 2015/0193625 A1
(43) Pub. Date: Jul. 9, 2015

(54) DISPLAY DEVICE

(71) Applicant: Innolux Corporation, Chu-Nan (TW)

(72) Inventor: Naoki SUMI, Chu-Nan (TW)

(73) Assignee: Innolux Corporation, Chu-Nan (TW)

(21) Appl. No.: 14/147,053

(22) Filed: Jan. 3, 2014

(51) Int. Cl. G06F 21/60; G06F 3/01; G09G 3/00

(52) U.S. Cl. CPC G06F 21/60; G09G 3/002; G06F 3/013; G09G 2358/00; G09G 2320/0613; G06F 2221/2105

(57) ABSTRACT

A controlling method of a display device is provided. The display device includes an optical modulating panel with an optical modulating layer and a display panel with a display layer. Firstly, a viewing position is sensed, and an azimuthal angle and a polar angle of the display device with respect to the viewing position are obtained accordingly. Then, an orientation mode of the display device is judged according to the azimuthal angle. Then, one of the optical modulating layer and the display layer is selectively adjusted according to the orientation mode and the polar angle of the display device.

### FIELD OF THE INVENTION

The present invention relates to a display device, and more particularly to a display device with anti-peep function.

### BACKGROUND OF THE INVENTION

With increasing development of science and technology, portable display device such as smart phones and tablet computers become more popular. For increasing the personal privacy and security, it is important to provide an anti-peep function to the display device. Conventionally, the anti-peep function is achieved by attaching a light control film (LCF).

The LCF provides the function of a micro louver. That is, the image contents of the display device can only be seen by main viewer in normal direction, but cannot be seen by bystanders. However, the conventional anti-peep function still has some drawbacks. While the viewing position of the main viewer is shifted, the image contents could be partially blocked by the opaque layers of LCF. Therefore, how to provide an improved anti-peep function with quality image performance for the main viewer is a challenge for all developers.

### SUMMARY OF THE INVENTION

An embodiment of the present invention provides a controlling method of a display device. The display device includes an optical modulating panel and a display panel. Firstly, a viewing position is sensed, and an azimuthal angle and a polar angle of the display device with respect to the viewing position are obtained accordingly. Then, an orientation mode of the display device is judged according to the azimuthal angle. Then, one of the optical modulating panel and the display panel is selectively adjusted according to the orientation mode and the polar angle of the display device.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic side view illustrating an exemplary display unit of the display device, in which the optical modulating mode is barrier type;

FIG. 2A is a schematic side view illustrating the relationship between the first viewing position P1 and the display unit according to the first setting situation;

FIG. 2B is a schematic side view illustrating the relationship between the second viewing position P2 and the display unit according to the second setting situation;

FIG. 3A is a schematic front view illustrating the relationship between the optical modulating layer and the display layer in the portrait privacy view mode;

FIG. 3B is a schematic front view illustrating the relationship between the optical modulating layer and the display layer in the landscape privacy view mode;

FIGS. 4A, 4B, 4C, 4D and 4E are schematic side views illustrating the operations of the optical modulating layer in the portrait privacy view mode;

FIGS. 5A, 5B, 5C, 5D, 5E and 5F are schematic side views illustrating the operations of the display layer in the landscape privacy view mode;

FIG. 6A is a schematic top view illustrating the arrangement of the electrodes;

FIG. 6B is a schematic top view illustrating the arrangement of the electrodes;

FIG. 7 is a schematic timing waveform diagram illustrating the voltage pattern applied to the electrodes;

FIG. 8 is a table illustrating the voltage patterns applied to the electrodes in different view modes;

FIG. 9 is a summary table illustrating the method of controlling the optical modulating panel and the image data of the display panel in the privacy 2D view mode;

FIG. 10 is a schematic functional block diagram illustrating the display unit with the anti-peep function;

FIG. 11 is a schematic functional block diagram illustrating the privacy view control block;

FIG. 12A schematically illustrates a method of judging whether the display unit is operated in the portrait privacy view mode or the landscape privacy view mode according to the azimuthal angle;

FIG. 12B schematically illustrates the method of determining the setting situation of the optical modulating layer in the portrait privacy view mode;

FIG. 12C schematically illustrates the method of determining the data set of the display unit in the landscape privacy view mode;

FIG. 13 is a schematic functional block diagram illustrating the display unit with the anti-peep function and the 3D viewing function;

FIG. 14 is a summary table illustrating the method of controlling the optical modulating panel and the image data of the display panel in the 3D view mode;

FIG. 15 is a schematic functional block diagram illustrating the 3D view control block;

FIG. 16A schematically illustrates a method of judging whether the display unit is operated in the 3D portrait view mode or the 3D landscape view mode according to the azimuthal angle;

FIG. 16B schematically illustrates the method of determining the data set of the display unit in the 3D portrait view mode;

FIG. 16C schematically illustrates the method of determining the setting situation of the optical modulating layer in the 3D landscape view mode; and

FIG. 17 is a plot illustrating the relationship between the brightness and the viewing angle of the display unit.

### DETAILED DESCRIPTION OF PREFERRED EMBODIMENTS

The present invention provides a display device with anti-peep function and a controlling method thereof. For meeting the requirement of quality image contents performance for the main viewer (host) at any appropriate viewing position under 2D mode, anti-peep mode or 3D mode. According to the controlling method of the present invention, the display device could be operated in a 2D view mode or a 3D view mode. According to an orientation mode of the display device, the display device could be operated in a portrait privacy view mode or a landscape privacy view mode. In accordance with the present invention, the eye/face/head position of the main viewer could be acquired by an eye tracking technology. The display device comprises a display unit, a control unit and an eye tracking unit. The eye tracking unit captures an image including viewing position of a main viewer.

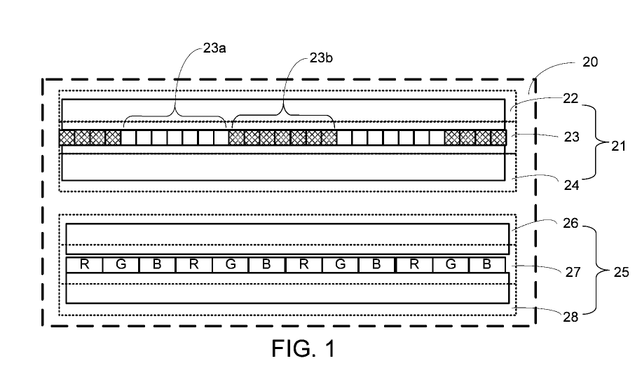

Refer to FIG. 1, the display unit 20 comprises an optical modulating panel 21 and a display panel 25. The optical modulating panel 21 is disposed between the viewer and the display panel 25. The optical modulating panel 21 is for anti-peep/normal or 2D/3D mode switch. The display panel 25 is for displaying image contents. In this embodiment, the optical modulating method for achieving anti-peep/normal or 2D/3D mode switch is barrier type. In other embodiment, lens (GRIN) type is also works. That is, the optical modulating panel may comprise a plurality of pixels and the pixels form a lens pattern.

In FIG. 1 the optical modulating panel 21 comprises a first substrate 22, a second substrate 24, and an optical modulating layer 23 there between. The optical modulating layer 23 comprises a plurality of pixels filled of optical material like liquid crystal for modulating the light transparency. The first substrate 22 and the second substrate 24 each comprises a plurality of electrodes for controlling the optical material and a pair of polarizer for forming a barrier pattern. The electrodes are disposed between those substrates and the optical material. According to a voltage difference between the electrodes, the barrier pattern is consequently formed by interlaced transparent lines and black lines. The transparent lines are the pixels of the optical modulating layer 23 turned on (light transparent mode), and the black lines are the pixels of the optical modulating layer 23 turned off (light block mode).

In FIG. 1, the display panel 25 comprises a third substrate 26, a forth substrate 28, and a display layer 27 there between. The display layer 27 comprising a plurality of sub-pixels (R, G, B). The sub-pixels are filled of optical unit like liquid crystal cell, organic light-emitting diode (OLED), or electronic paper display (EPD). Other structure of the display panel 25 is the same with normal display. The display panel 25 accepts image data input from the control unit for achieving normal, anti-peep (true-false), or 3D (left-right) functions with the optical modulating panel 21.

More especially, regardless of whether the display unit 20 is operated in portrait 2D view mode, landscape 2D view mode, portrait privacy view mode, landscape privacy view mode, portrait 3D view mode, or landscape 3D view mode, the display unit 20 can be dynamically adjusted according to the change of viewing position of the main viewer by an eye tracking system and algorithm.

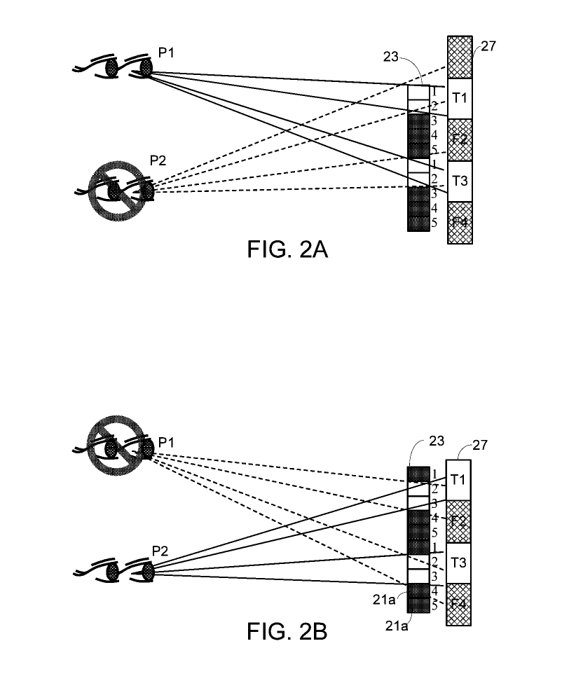

FIG. 2A is a schematic side view illustrating the relationship between the first viewing position P1 and the display unit 20 according to the first setting situation. The display layer 27 includes a plurality of sub-pixels, and the optical modulating layer 23 includes a plurality of pixels. The barrier pattern of the optical modulating layer 23 is formed by a plurality of interlaced light transparent areas 23 and light blocking areas 23b. The display layer 27 shows a image formed by a plurality of alternate true image data T and false image data F. In the embodiment, the light transparent area 23 comprises 2 pixels and the light blocking area 23b comprises 3 pixels.

When the main viewer is located at the first viewing position P1, the true image data T of the display layer 27 can be clearly seen through the light transparent areas 23a. On the other hand, a bystander at the second viewing position P2 see a mixture result of true image data T and false image data F through the light transparent areas 23a. The bystander catches an unidentifiable image, and the anti-peep function works.

Compared to the barrier pattern in FIG. 2A, the barrier pattern in FIG. 2B is shifted. When the main viewer is located at the second viewing position P2, the true image data T can be clearly seen by the main viewer. A bystander at the first viewing position P1 sees a unidentifiable mixture result of true image data T and false image data F.

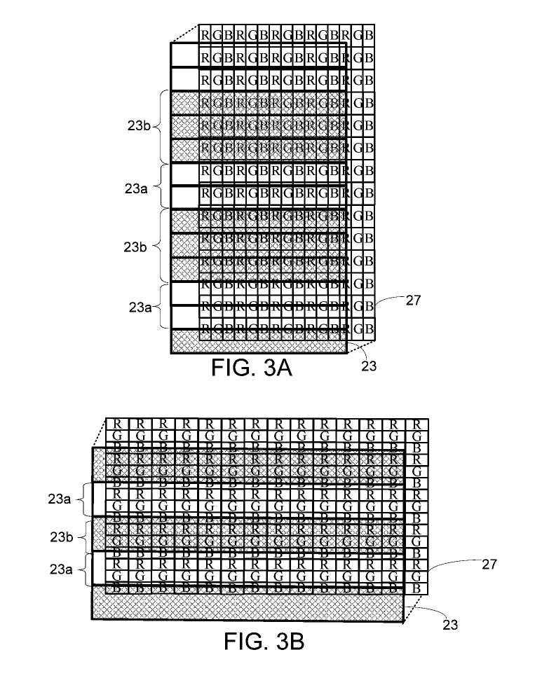

FIG. 3A is a schematic view illustrating the relationship between the optical modulating panel 21 and the display panel 25 in the portrait privacy view mode. As shown in FIG. 3A, the sub-pixels R, G and B of the display panel 25 are sequentially arranged in a row from left to right. The optical modulating layer 23 is composed of a plurality of discrete pixel rows. These pixel rows are controlled alternately in the light block and the light transparent modes hence a barrier pattern forms.

FIG. 3B is a schematic view illustrating the relationship between the optical modulating panel 21 and the display panel 25 in the landscape privacy view mode. As shown in FIG. 3B, the sub-pixels R, G and B of display panel 25 are sequentially arranged in a column from top to bottom. The optical modulating layer 23 is composed of a plurality of discrete pixel rows. These pixel rows are controlled alternately in the light block and the light transparent modes hence a barrier pattern forms. The barrier patterns (barrier rows) in portrait privacy view mode and landscape privacy view mode are similar.

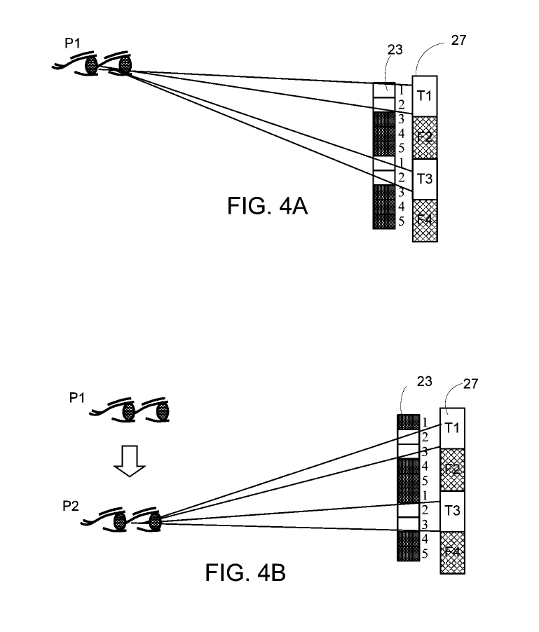

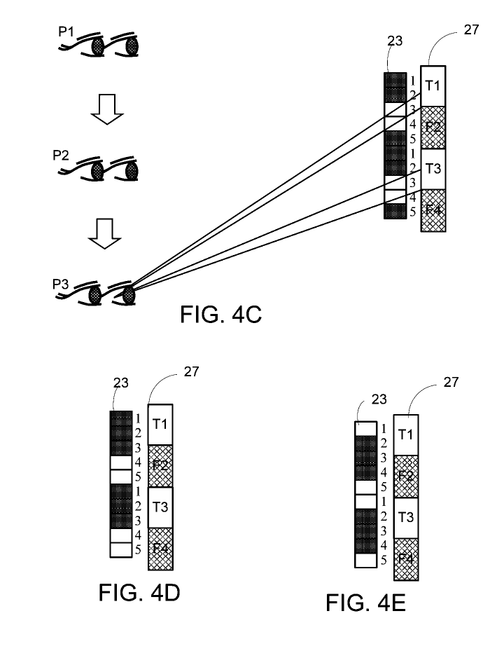

FIGS. 4A, 4B, 4C, 4D and 4E are schematic side views illustrating the operations of the optical modulating panel 21 in the portrait privacy view mode according to five different setting situations. As mentioned above, when the display unit 20 is operated in the portrait privacy view mode, the image data (true-false image pattern) of the display panel 25 is fixed, and the barrier pattern of the optical modulating layer 23 is selectively depended on the viewing position of the main viewer.

Please refer to FIG. 4A. The viewing position of the main viewer is at the first viewing position P1. There are 5 rows of pixels of the optical modulating layer 23 in a group. In each group, a light transparent area 23a comprises two rows (1^{st} 2^{nd}) of pixels and a light blocking area 23b comprises three rows (3^{th}, 4^{th}, 5^{th}) of pixels. Through the light transparent area 23a, the main viewer could clearly see true image data (T1,T3) of the display panel 25, but other bystanders in different viewing position just see mixture result of true image data T and false image data F.

Please refer to FIG. 4B. The main viewer shifts to the second viewing position P2. The light transparent area 23a is shift to 2^{nd} and 3^{rd} rows and the light blocking area 23b is shift to 4^{th}, 5^{th} and 1^{st} rows. From FIG. 4A to FIG. 4E, the image data of the display panel 25 is fixed, but the barrier pattern of the light transparent area 23a and the light blocking area 23b cyclically rotates.

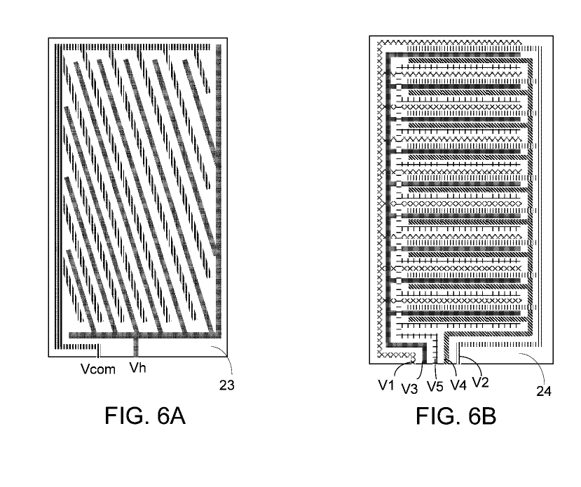

Hereinafter, the setting situations of FIGS. 6A, 6B, 6C, 6D and 6E are referred as a first setting situation S1, a second setting situation S2, a third setting situation S3, a fourth setting situation S4 and a fifth setting situation S5, respectively. In the portrait privacy view mode, one of the five setting situations is selected to control the optical modulating display 21. Of course, the setting situations are not restricted.

As mentioned above, when the display unit 20 is operated in the portrait privacy view mode, the setting situations of the optical modulating panl 21 are dynamically determined according to the viewing position of the main viewer. On the other hand, when the display unit 20 is operated in the landscape privacy view mode, the setting situation of the optical modulating panel 21 is fixed, but the image data set of the display panel 25 is dynamically determined according to the viewing position of the main viewer.

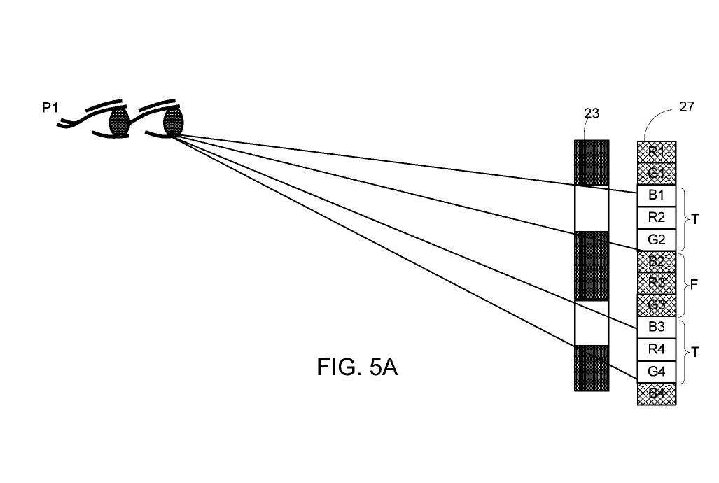

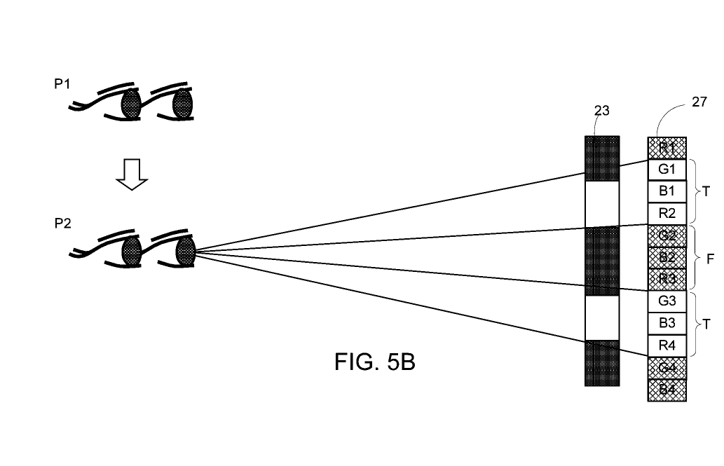

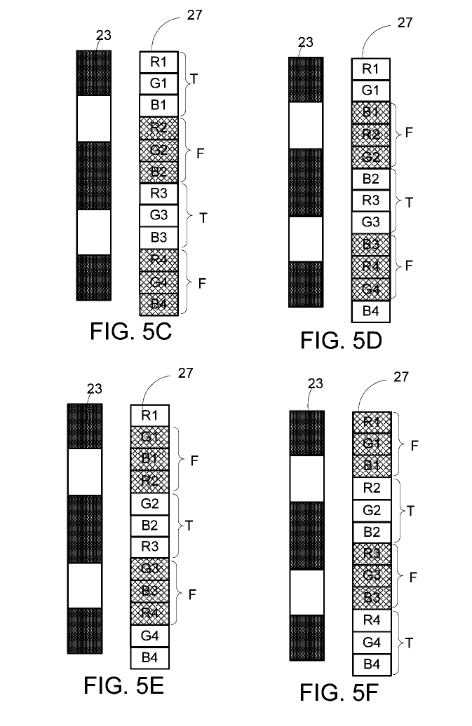

FIGS. 5A, 5B, 5C, 5D, 5E and 5F are schematic side views illustrating the operations of the display panel 25 of the display unit 20 in the landscape privacy view mode. When the display unit 20 is operated in the landscape privacy view mode, the setting situation of the optical modulating panel 21 is fixed, but the image data set of the display layer 27 of the display panel 25 is dynamically determined according to the viewing position of the main viewer. In this embodiment, the even rows of the optical modulating layer 23 are light transparent and the odd rows of the optical modulating layer 23 are light blocking. The setting situation of the optical modulating panel 21 is fixed.

In FIGS. 5A, 5B, 5C, 5D, 5E and 5F, a first pixel 22a, a second pixel 22a, a third pixel 22a and a fourth pixel 22a of the display layer 22 are sequentially shown (from top to bottom). Each pixel 22a includes three sub-pixels R, G and B in the order of R, G and B. The contents of the image data of each sub-pixel can be true or false independently. In these drawings, the false image data are marked by screentones, and the true image data are indicated as blank regions.

Please refer to FIG. 5A. The viewing position of the main viewer is at the first viewing position P1. The image contents of the display panel 25 can be clearly seen by the main viewer through the light transparent area 23a of the optical modulating layer 23. From top to bottom of the display layer 27, the sub-pixels R1 and G1 of the false image data, the sub-pixels B1, R2 and G2 of the true image data, the sub-pixels B2, R3 and G3 of the false image data, the sub-pixels B3, R4 and G4 of the true image data and the sub-pixel B4 of the false image data are sequentially shown. In FIG. 5A, the pixels of the display layer 27 constitute a first image data set C1 (FFTTTF).

Please refer to FIG. 5B. The viewing position of the main viewer is shifted to the second viewing position P2. From top to bottom of the display layer 27, the sub-pixel R1 of the false image data, the sub-pixels G1, B1 and R2 of the true image data, the sub-pixels G2, B2 and R3 of the false image data, the sub-pixels G3, B3 and R4 of the true image data and the sub-pixels G4 and B4 of the false image data are sequentially shown. In FIG. 5B, the pixels of the display layer 27 constitute a second data set C2 (FTTTFF).

In FIG. 5C, the pixels of the display layer 27 constitute a third data set C3 (TTTFFF). In FIG. 5D, the pixels of the display layer 27 constitute a fourth data set C4 (TTFFFT). In FIG. 5E, the pixels 22a constitute a fifth data set C5 (TFFFTT). In FIG. 5F, the pixels 22a constitute a sixth data set C6 (FFFTTT).

FIG. 6A is a schematic top view illustrating the arrangement of the transparent electrodes (ITO) of the optical modulating panel 21, which is disposed on the first substrate 22. There are a plurality of interlaced common voltage electrodes Vcom and high voltage electrodes Vh arranged incline to the display panel 25 for reducing moire.

FIG. 6B is a schematic top view illustrating the arrangement of the transparent electrodes (ITO) of the optical modulating panel 21, which are disposed on the second substrate 24. There are a plurality of interlaced electrodes including a first electrode V1, a second electrode V2, a third electrode V3, a fourth electrode V4 and a fifth electrode V5 sequentially arranged along the horizontal direction to the display panel 25.

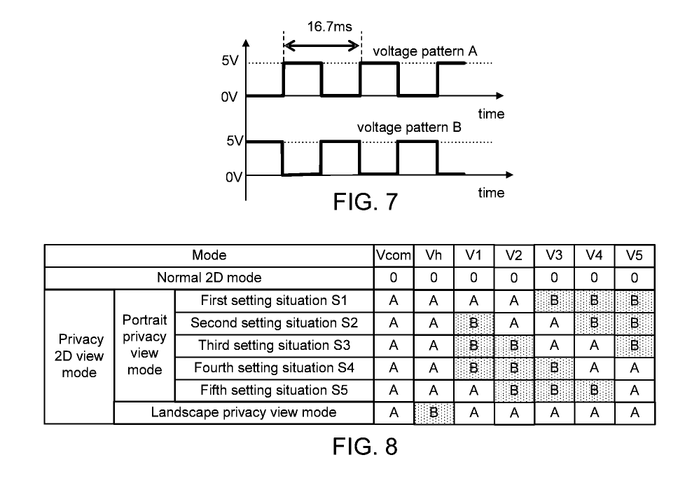

FIG. 7 is a schematic timing waveform diagram illustrating the voltage pattern applied to the display panel. A voltage pattern A and a voltage pattern B have the same cycle (e.g. 16.7 ms), and phases of the voltage pattern A and the voltage pattern B are opposite. That is, if the voltage pattern A is in the high level state (5V), the voltage pattern B is in the low level state (0V), and vice versa. The voltage difference between the electrodes of the optical modulating panel 21 makes barrier patterns formed by the light transparent area 23a and the light blocking area 23b.

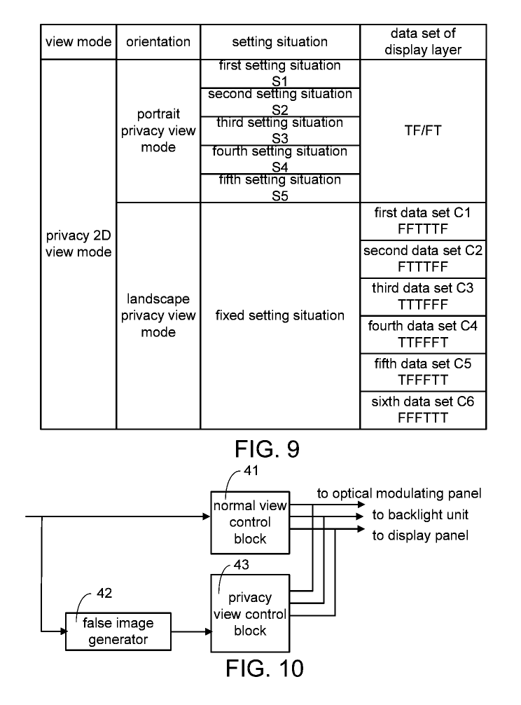

FIG. 8 is a table illustrating the voltage patterns applied to the electrodes of the optical modulating panel 21 in different view modes. The columns of FIG. 10 indicate the voltage patterns of the common voltage electrode Vcom, the high voltage electrode Vh, the first electrode V1, the second electrode V2, the third electrode V3, the fourth electrode V4 and the fifth electrode V5 (from left to right). The rows of FIG. 10 indicate different view modes, including the normal 2D mode and the privacy 2D view mode (from top to bottom). The privacy 2D view mode further includes the portrait privacy view mode and the landscape privacy view mode.

In the normal 2D mode, the anti-peep function is not enabled. Under this circumstance, the voltage levels of the common voltage electrode Vcom, the high voltage electrode Vh, the first electrode V1, the second electrode V2, the third electrode V3, the fourth electrode V4 and the fifth electrode V5 are all 0V. Consequently, all pixels of the optical modulating layer 23 are transparent. Meanwhile, the image contents of the display panel 25 can be directly seen.

In the portrait privacy view mode, the first setting situation S1, the second setting situation S2, the third setting situation S3, the fourth setting situation S4 and the fifth setting situation S5 are correlated with the first electrode V1, the second electrode V2, the third electrode V3, the fourth electrode V4 and the fifth electrode V5, respectively. That is, the voltage levels of the common voltage electrode Vcom and the high voltage electrode Vh are kept unchanged (voltage pattern A), but the voltage levels of the electrodes disposed on the other substrate are adjusted according to different conditions. Alternatively, in some other embodiments, the voltage pattern B may be applied to the common voltage electrode Vcom and the high voltage electrode Vh.

In the landscape privacy view mode, the voltages of the electrodes on the second substrate 24 are kept unchanged, but the voltage of one of the common voltage electrode Vcom and the high voltage electrode Vh is changed. In this embodiment, the voltage pattern A is applied to the common voltage electrode Vcom and the first electrode V1, the second electrode V2, the third electrode V3, the fourth electrode V4 and the fifth electrode V5, and the voltage pattern B is applied to the high voltage electrode Vh.

Alternatively, in another embodiment of the landscape privacy view mode, the voltage pattern A is applied to the high voltage electrode Vh, the first electrode V1, the second electrode V2, the third electrode V3, the fourth electrode V4 and the fifth electrode V5, and the voltage pattern B is applied to the common voltage electrode Vcom. Alternatively, in some other embodiments of the landscape privacy view mode, the voltage pattern B could replace by the voltage pattern A.

FIG. 9 is a summary table illustrating the method of controlling the optical modulating panel 21 and the display panel 25. In the portrait privacy view mode of the display device 20, the setting situations of optical modulating panel 21 include the first setting situation S1, the second setting situation S2, the third setting situation S3, the fourth setting situation S4 and the fifth setting situation S5. Under this circumstance, the data set of the display layer 27 is TF or FT. In the landscape privacy view mode, the display layer 27 constitutes a first data set C1 (FFTTTF, see FIG. 5A), the second data set C2 (FTTTFF, see FIG. 5B), the third data set C3 (TTTFFF, see FIG. 5C), the fourth data set C4 (TTFFFT, see FIG. 5D), the fifth data set C5 (TFFFTT, see FIG. 5E) and the sixth data set C6 (FFFTTT, see FIG. 5F).

FIG. 10 is a schematic functional block diagram illustrating the control unit of the display device 20 with the anti-peep function. The upper transmission path is the normal view mode path. The lower transmission path is the privacy view mode path. There are a normal view control block 41, a false image generator 42 and a privacy view control block 43 inside.

The false image generator 42 may be implemented by any other appropriate algorithm. In an embodiment, the false image data may be obtained by gray level inversion. In case that the true image has a gray level G, the false image data outputted from the false image generator 42 has a gray level (255-G). Alternatively, in another embodiment, the false image may be obtained according to the combination of the viewing position and the gray level of the pixel. For example, in case that the pixel at the position coordinate (x,y) has the gray level G(x,y), the false image data outputted from the false image generator 42 has a gray level G(x+rand(5),y). The term rand(5) indicates that 5 is used as a random seed to generate the random number, and the term (x+rand(5)) indicates that the new x position is equal to the sum of the original x position and the random number rand(5).

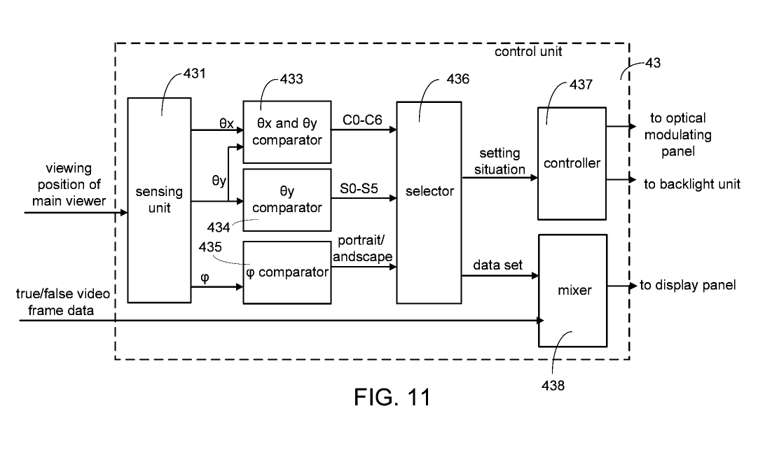

FIG. 11 is a schematic functional block diagram illustrating the privacy view control block. As shown in FIG. 11, the privacy view control block 43 includes a sensing unit 431, a polar angle θx and θy comparator 433, a polar angle θy comparator 434, an azimuthal angle φ comparator 435, a selector 436, a controller 437, and a mixer 438. According a viewing position of a main viewer transmitted from the eye tracking unit, the sensing unit 431 can output the azimuthal angle φ, the x-axis component polar angle θx and the y-axis component polar angle θy data information. The selector 436 selects a setting situation and outputs data signals for the optical modulating layer 23 and the display layer 27. In case that the setting situation is selected, the setting situation is transmitted to the controller 437, and then a control signal is outputted from the controller 437 to the optical modulating panel 21 and the backlight unit (not shown). In case that the data set is selected, the data set outputted to the mixer 438. The mixer 438 mixes the data set and a true & false image data.

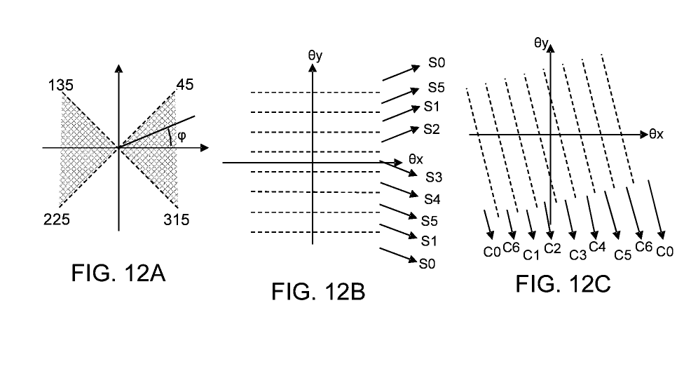

FIG. 12A schematically illustrates a method of judging whether the display unit 20 is operated in the portrait privacy view mode or the landscape privacy view mode according to the azimuthal angle cp. In case that the azimuthal angle φ is in the range between −45 (or 315) and 45 degrees or in the range between 135 and 225 degrees, the azimuthal angle φ comparator 435 judges that the display device 20 is operated in the portrait privacy view mode (barrier shift). If the azimuthal angle φ0 is in the range between 45 and 135 degrees or in the range between 225 and 315 degrees, the azimuthal angle φ comparator 435 judges that the display device 20 is operated in the portrait landscape view mode (display shift). After the current orientation mode of the display unit 20 is judged, the judging result outputted from the azimuthal angle φ comparator 435 to the selector 436.

FIG. 12B schematically illustrates the method of determining the setting situation of the optical modulating layer 23 in the portrait privacy view mode. In this step, only the change of the y-axis component polar angle θy is taken into consideration by the polar angle θy comparator 434. The y-axis component polar angle θy is divided into a plurality of sub-ranges. The topmost sub-range and the bottommost sub-range indicate that the display unit 20 is turned off (S0). Since the y-axis component polar angle θy is too large, it means that the display unit 20 is no longer used by the main viewer. Under this circumstance, the display unit 20 is turned off. The other sub-ranges indicate the setting situations S1, S2, S3, S4, and S5.

The range of dynamically tracking the eye position may be limited to a predetermined angle (e.g. 30 degrees). That is, the function of dynamically tracking the eye position is achievable only when the polar angle θ with respect to the center of the display unit 20 is smaller than 30 degrees. If the polar angle θ is larger than 30 degrees, the display unit 20 is directly turned off.

FIG. 12C schematically illustrates the method of determining the data set of the display layer 27 in the landscape privacy view mode. In this step, the changes of x-axis component polar angle θx and y-axis component polar angle θy are taken into consideration by the polar angle θx and the polar angle θy comparator 433. The x-axis component polar angle θx and y-axis component polar angle θy may be divided into a plurality of sub-range. The leftmost sub-range and the rightmost sub-range indicate that the display unit 20 is turned off (C0). Since the viewing angle of the display unit device 20 is too large, it means that the display unit 20 is no longer used by the main viewer. Under this circumstance, the display unit 20 is turned off. The other sub-ranges indicate the data sets C1, C2, C3, C4, C5 and C6.

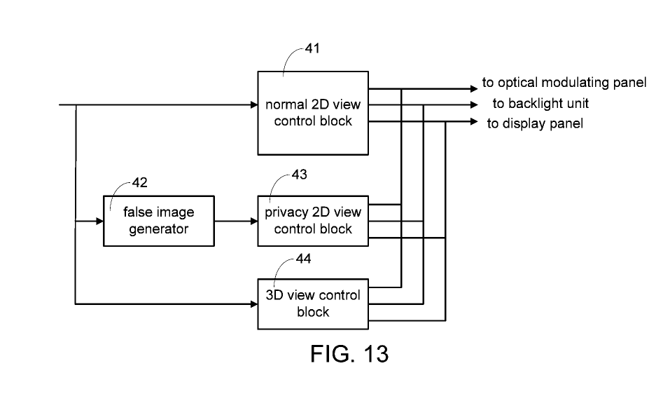

FIG. 13 is a schematic functional block diagram illustrating the display device with the anti-peep function and the 3D viewing function. The architecture of FIG. 13 is similar to the architecture of FIG. 10. In comparison with FIG. 10, the architecture of FIG. 13 further includes a 3D view mode transmission path. In the 3D view mode, the optical modulating panel 21 is used to separate left view image (L) and right view image (R) to left eye and each eye, respectively. For achieving this purpose, the barrier patterns of the optical modulating panel 21 are column type (i.e. vertical stripes), perpendicular to the row type barrier patterns of anti-peep function.

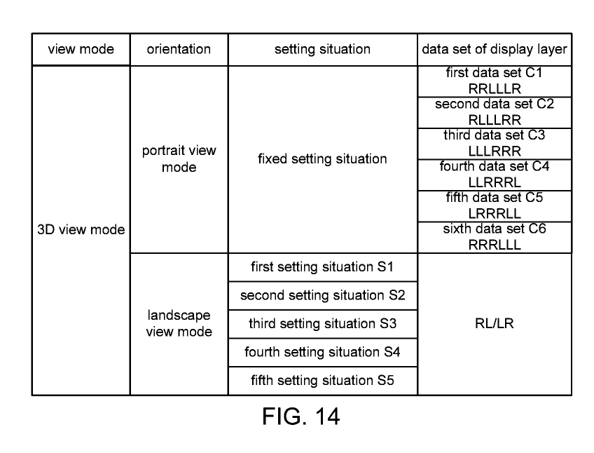

FIG. 14 is a summary table illustrating the method of controlling the optical modulating panel 21 and the image data of the display panel 25 in the 3D view mode. In the 3D portrait view mode of the display panel 20, the setting situation of the optical modulating layer 23 is kept unchanged but the data set provided by the display layer 23 is dynamically changed. The same column of the optical modulating layer 23 are simultaneously turned on or turned off. For example, the first and second pixel columns of the optical modulating layer 23 are simultaneously turned on (light transparent), but the third, forth, and fifth columns of the optical modulating layer 23 are simultaneously turned off (light block). The display layer 27 constitutes a first data set C1 (RRLLLR), the second data set C2 (RLLLRR), the third data set C3 (LLLRRR), the fourth data set C4 (LLRRRL), the fifth data set C5 (LRRRLL) and the sixth data set C6 (RRRLLL).

In the 3D landscape view mode of the display panel 20, the setting situations of optical modulating layer 23 include the first setting situation S1, the second setting situation S2, the third setting situation S3, the fourth setting situation S4 and the fifth setting situation S5. In the first setting situation S1, the first and fifth barrier columns are turned on, but the second, third the fourth barrier columns are turned off. In the second setting situation S2, the first and the second barrier columns are turned on, but the third, fourth and fifth barrier columns are turned off. In the third setting situation S3, the second and third barrier columns are turned on, but the first, fourth and fifth barrier columns are turned off. In the fourth setting situation S4, the third and fourth barrier columns are turned on, but the first, second and fifth barrier columns are turned off. In the fifth setting situation S5, the fourth and fifth barrier columns are turned on, but the first, second and third barrier columns are turned off. Under this circumstance, the data set of the display layer 27 is RL or LR.

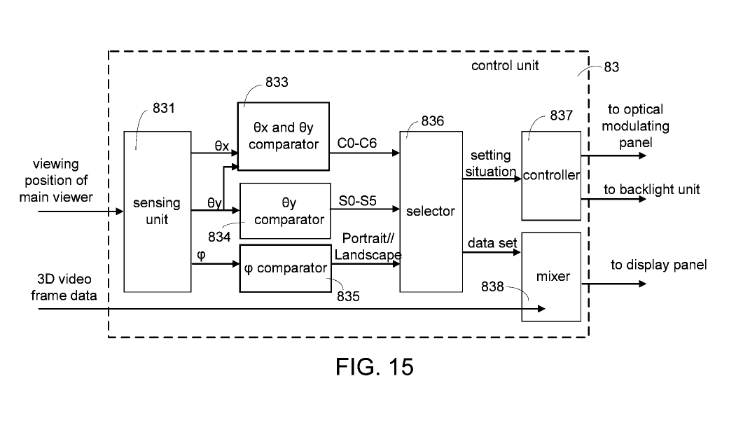

FIG. 15 is a schematic functional block diagram illustrating the 3D view control block. As shown in FIG. 28, the 3D view control block 83 includes a sensing unit 831, a polar angle θx and polar angle θy comparator 833, a polar angle θy comparator 834, an azimuthal angle φ comparator 835, a selector 836, a controller 837, and a mixer 838. According to the azimuthal angle φ, the x-axis component polar angle θx and the y-axis polar angle component θy, the selector 836 may select a setting situation of the optical modulating layer 23 and the data set of the display layer 27. In case that the setting situation is selected, the setting situation is transmitted to the controller 837, and then a control signal is transmitted from the controller 837 to the optical modulating layer 23 and the backlight plate (not shown). In case that the data set is selected, the data set is transmitted to the mixer 838. Moreover, after a 3D video frame data and the data set from the selector 836 are mixed by the mixer 838, a mixed data is transmitted to the display layer 27.

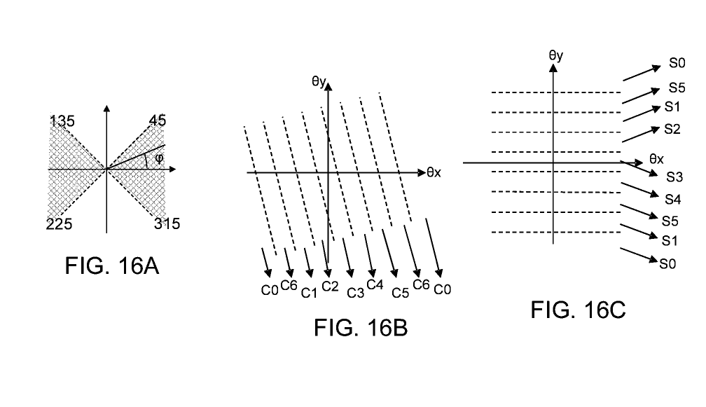

FIG. 16A schematically illustrates a method of judging whether the display unit 20 is operated in the 3D portrait view mode or the 3D landscape view mode according to the azimuthal angle φ. In case that the azimuthal angle φ is in the range between −45 (or 315) and 45 degrees or the azimuthal angle φ is in the range between 135 and 225 degrees, the azimuthal angle φ comparator 835 judges that the display unit 20 is operated in the 3D portrait view mode (display shift). If the azimuthal angle φ is in the range between 45 and 135 degrees or the azimuthal angle φ is in the range between 225 and 315 degrees, the azimuthal angle φ comparator 835 judges that the display unit 20 is operated in the 3D landscape view mode (barrier shift). After the current orientation mode of the display unit 20 is judged, the judging result is transmitted from the azimuthal angle φ comparator 835 to the selector 836.

FIG. 29B schematically illustrates the method of determining the data set of the display layer 27 in the 3D portrait view mode. In case that the display unit 20 is operated in the 3D portrait view mode, it is necessary to determine the data set of the image data according to the θx and θy, one of the 2D data set and the data sets C1, C2, C3, C4, C5 and C6 is determined.

In FIG. 16B, The x-axis direction component θx and y-axis direction component θy may be divided into plural sub-ranges. The leftmost sub-range and the rightmost sub-range indicate the 2D data set C0. Since the viewing angle of the display unit 20 is too large, it means that the display unit 20 is no longer operated in the 3D view mode. Under this circumstance, the 2D data set is shown on the display panel 25. The other sub-ranges indicate the data sets C1, C2, C3, C4, C5 and C6.

FIG. 16C schematically illustrates the method of determining the setting situation of the optical modulating layer 23 in the 3D landscape view mode. After the y-axis direction component θy of the display unit 20 is detected, one of a 2D setting situation and the setting situations S1, S2, S3, S4 and S5 is determined.

In the above embodiments, the optical units of the optical modulating layer 23 are barrier cells. Alternatively, in some other embodiments, gradient-index (GRIN) optical lens cells are used as the optical units of the optical modulating layer 23.

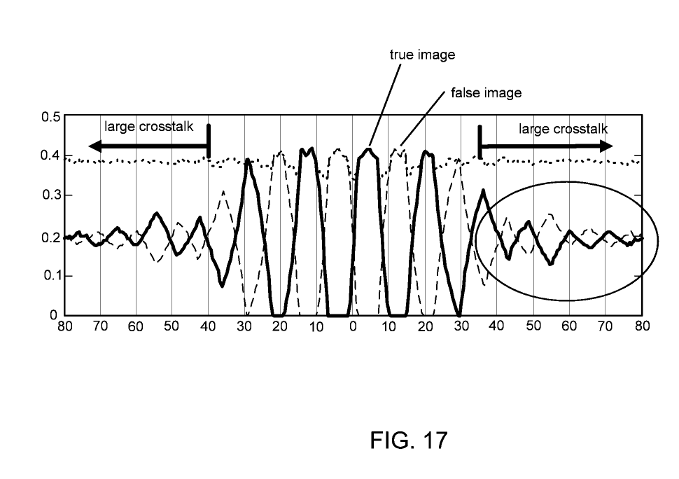

FIG. 17 is a plot illustrating the relationship between the brightness and the viewing angle of the optical lens cell. If the viewing angle is too large, the true image data T and the false image data F are mixed by the defocusing operation of the optical lens cell, and thus crosstalk generated. Due to the mixing of the true image data T and the false image data F in large viewing angle position, bystanders in the side position cannot recognize the true image. Consequently, the anti-peep function is enhanced.

The controlling method of the present invention may be applied to various display devices. The setting situation of the optical modulating layer 23 can be dynamically adjusted to provide satisfied viewing function. In the 2D view mode, the anti-peep function is dynamically adjusted according to the vision line of the main viewer. In the 3D view mode, the 3D viewing function is dynamically adjusted according to the viewing position of the main viewer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a display panel;
an optical modulating panel, between the display panel and a viewer;
a sensing unit, for defining an azimuthal angle and a polar angle between the display device and the viewer; and
a selector connected with the sensing unit, the display panel, and the optical modulating panel,
wherein the selector outputs a plurality of data signals to the display panel and the optical modulating panel,
wherein an orientation mode of the display device is defined according to the azimuthal angle,
wherein the data signals are adjusted according to the orientation mode and the polar angle.

2. The display device as claimed in claim 1, wherein the optical modulating panel comprises a plurality of pixels and the pixels form a barrier pattern with interlaced light transparent areas and light blocking areas.

3. The display device as claimed in claim 2, wherein the display panel comprises a plurality of sub pixels, and the sub pixels form a display image with a plurality of interlaced true image data and false image data as the display device is in anti-peep mode.

4. The display device as claimed in claim 3, wherein if the azimuthal angle is in a range from −45 degree to 45 degree or a range from 135 degree to 225 degree, the orientation mode of the display device is a portrait mode.

5. The display device as claimed in claim 4, wherein an arrangement of the true image data and the false image data of the display image is unchanged, and an arrangement of the light transparent areas and the light blocking areas of the barrier pattern is shifted according to the polar angle.

6. The display device as claimed in claim 3, wherein if the azimuthal angle is in a range from 45 degree to 135 degree or a range from 225 degree to 315 degree, the orientation mode of the display device is a landscape mode.

7. The display device as claimed in claim 6, wherein an arrangement of the true image data and the false image data of the display image is shifted according to the polar angle, and an arrangement of the light transparent areas and the light blocking areas of the barrier pattern is unchanged.

8. The display device as claimed in claim 3, wherein the sub pixels of the display panel are formed by an display layer and a plurality of electrodes.

9. The display device as claimed in claim 8, wherein the optical modulating layer comprises liquid crystal or OLED.

10. The display device as claimed in claim 2, wherein the display panel comprises a plurality of sub pixels, and the sub pixels form a display image with a plurality of interlaced left view image data and right view image data as the display device is in 3D mode.

11. The display device as claimed in claim 10, wherein if the azimuthal angle is in a range from −45 degree to 45 degree or a range from 135 degree to 225 degree, the orientation mode of the display device is a portrait mode.

12. The display device as claimed in claim 11, wherein an arrangement of the left view image data and the right view image data of the display image is shifted according to the polar angle, and an arrangement of the light transparent areas and the light blocking areas of the barrier pattern is unchanged.

13. The display device as claimed in claim 10, wherein if the azimuthal angle is in a range from 45 degree to 135 degree or a range from 225 degree to 315 degree, the orientation mode of the display device is a landscape mode.

14. The display device as claimed in claim 13, wherein an arrangement of the left view image data and the right view image data of the display image is unchanged, and an arrangement of the light transparent areas and the light blocking areas of the barrier pattern is shifted according to the polar angle.

15. The display device as claimed in claim 2, wherein the pixels of the optical modulating panel are formed by an optical modulating layer and a plurality of electrodes.

16. The display device as claimed in claim 15, wherein the optical modulating layer comprises liquid crystal.

17. The display device as claimed in claim 1, wherein the optical modulating panel comprises a plurality of pixels and the pixels form a lens pattern.

18. The display device as claimed in claim 1, the display device further comprises:
a controller, electrically connected with the selector and the optical modulating panel; and
a mixer, electrically connected with the selector and the display panel,
wherein the data signals with a setting from the selector are transported to the optical modulating panel through the controller, and the other data signals with another setting from the selector are transported to the display layer through the mixer.

19. The display device as claimed in claim 18, wherein the data signals is mixed with a true and false image data by the mixer.

20. The display device as claimed in claim 1, wherein an eye tracking unit is connected to the sensing unit to output a viewing position to the sensing unit for defining the azimuthal angle and the polar angle.
